(19) United States
(12) Patent Application Publication
(10) Pub. No.: US 2007/0100081 A1
(43) Pub. Date: May 3, 2007

(54) Polymer compositions having novel cure systems and method of making articles with same

(75) Inventor: Kevin Grant Suddaby, Research Triangle Park, NC (US)

Correspondence Address: MYERS BIGEL SIBLEY & SAJOVEC, PO BOX 37428, RALEIGH, NC, 27627, US

(73) Assignee: Dow Reichhold Specialty Latex LLC

(21) Appl. No.: 11/266,027

(22) Filed: Nov. 3, 2005

(51) Int. Cl. C08F 136/00

(52) U.S. Cl. 525/331.9

(57) ABSTRACT

The present invention provides a polymer composition capable of being cured or crosslinked in the absence of conventional sulfur and accelerator cure systems. The polymer is formed from olefinically unsaturated monomers and includes at least one conjugated diene monomer. Such polymer includes additional functionality provided by a monomer which may crosslink via enamine formation, condensation with aldehydes, Michael addition, alkylation with alkyl halides, reaction with diisocyanates, or reaction with melamines. By these same mechanisms, the polymer may additionally or alternatively be reacted with a substrate, such as a fiber, to bind the polymer to the substrate. Further, the polymer may be reacted with a molecule, such as a plasticizer, dye, indicator, surface modifier, or antimicrobial moiety in order to bind the molecule to the polymer. Methods of making articles of manufacture that comprise the polymer compositions of the invention are also disclosed.

### FIELD AND BACKGROUND OF THE INVENTION

The present invention relates to polymer compositions and articles of manufacture that are useful in a wide variety of fields. Particularly, the compositions and methods of the present invention are useful in crosslinkable films, coatings, adhesives, gaskets, barrier films, membranes, and the like. The compositions and methods are particularly useful when there is a need to avoid using conventional cure systems, namely sulfur-based systems.

In general, many conventional polymer compositions used in articles of manufacture, such as films, coatings and adhesives, are prepared using sulfur-based cure systems. Sulfur-based linkages are introduced during the crosslinking of the polymer composition. In addition to sulfur, accelerators such as thiazoles, sulfonamides, dithiocarbonates and thiurams are normally utilized. It would be desirable to eliminate the use of sulfur-based crosslinking agents and accelerators which may generate nitrosamines and cause copper staining, allergies and sensitization to accelerator residues, and potential contamination of the films, coatings, and adhesives. The potential also exists for curing agents or curing agent residues that are not bound to the polymer chains to bloom to the surface of the polymer. In practice, this is sometimes seen as sulfur blooming and is undesirable since it can lead to particulate contamination, which is especially problematic in controlled environments. Blooming from the cure system can also alter performance properties in applications such as gasketing where it can interfere with adhesion or sealing properties.

Several alternatives to conventional cure systems exist, such as the incorporation of functionality into a polymer through the use of N-methylol acrylamide and its derivatives. While these provide suitable performance in some cases, acrylamide residues are undesirable in many applications.

Allergies and sensitization is particularly a problem in medical gloves made from polymer latex compositions. Latex gloves are preferred since they can be made light, thin, flexible, tight-fitting, and substantially impermeable to a variety of liquids and gases. It is often desirable that the gloves possess adequate physical properties, such as tensile strength and elongation, and are comfortable to the wearer. It is also desirable that the gloves possess adequate aesthetic properties with respect to drape, softness, etc., provide a good barrier to microbial penetration, and be substantially odorless. A combination of high tensile strength and elongation combined with a low modulus is typically preferred.

Conventional latex gloves have typically been formed of natural rubber primarily due to their resiliency, softness, adequate physical properties, and good elastic recovery. Nonetheless, many wearers of such gloves are allergic to proteins found in natural rubber. These individuals often experience difficulty when wearing the gloves. As a result, there have been efforts to develop gloves made from synthetic materials that are comparable to natural rubber gloves in terms of comfort and physical properties.

One synthetic alternative focuses on using poly(vinylchloride) (PVC). PVC is typically plasticized in order to be pliable enough to use in glove applications. Gloves formed from PVC are undesirable in many respects. For example, the gloves do not possess a soft and rubbery feel. Furthermore, the plasticizer may migrate through the PVC and leach out when in contact with solvents. Also, it is believed that synthetic gloves formed from these plasticized vinyl materials may provide an insufficient barrier to microbes due to imperfections in the film. Additionally, these gloves tend to display inadequate elastic recovery (snap) properties and poor softness. Various other glove materials are described in U.S. Pat. No. 5,014,362 to Tillotson, U.S. Pat. No. 5,910,533 to Ghosal et al., and U.S. Pat. No. 5,997,969 to Gardon.

There continues to be a need for polymer compositions and articles of manufacture that can be prepared in the absence of sulfur and accelerators. The polymer compositions that form such articles should have the desirable characteristics of conventional polymers, maintain the desired aesthetic and physical properties (e.g., high tensile strength and elongation properties), and obviate the undesirable features of polymers that occur when using conventional sulfur-based cure systems, namely blooming, copper staining, allergies and sensitization to accelerator residues, and contamination in articles of manufacture sensitive to sulfur or accelerator residues.

One example of a polymer composition that meets these criteria is disclosed in U.S. Pat. No. 6,624,274 to Suddaby. Suddaby discloses a polymer composition having a novel cure system, which optionally includes crosslinking with multivalent metal cations. While crosslinking with multivalent metal cations is useful for many applications, in some cases, it may be desirable to cure the polymer by other crosslinking methods. In addition, it would also be desirable to use the functionalities of the polymer composition to form chemical bonds between the polymer and fibers, surfaces, or other substrates containing co-reacting functionalities. Further, it would be desirable to chemically bind functional molecules, such as dyes, indicators, plasticizers, surface modifiers, and antimicrobial moieties, to the polymer composition, in order to prevent the functional molecules from migrating from the film.

### SUMMARY OF THE INVENTION

To these ends, and to other objects and advantages, the present invention provides polymers having novel cure systems and methods of making articles of manufacture from the polymers of the invention. The polymers are capable of being crosslinked or cured in the absence of conventional sulfur and/or accelerator cure systems, and may alternatively or additionally be reacted with substrates or functional molecules. The polymers comprise at least one olefinically unsaturated monomer, wherein the polymer contains at least one conjugated diene monomer and additional functionality is provided by a monomer having the structure 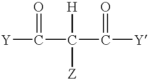
wherein 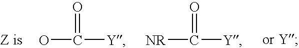
wherein Y,Y′, and Y″ are independently selected from the group consisting of NRR′, OR or R wherein R and R′ are independently selected from the group consisting of hydrogen and aliphatic, alicyclic, aromatic and heteroaromatic groups and wherein the structure has olefinic unsaturation.

Such a polymer can then be crosslinked or cured via a crosslinking system utilizing one of more of the following reactions: enamine formation, aldehyde condensation, Michael reaction, alkylation of alkyl halides, reaction with diisocyanates, and reaction with melamines. Further the reactive groups of the polymer may react with co-reacting functionalities of a substrate to bind the polymer composition to the substrate. The reactive groups of the polymer may further react with functional molecules, such as plasticizers, dyes, indicators, surface modifiers, and antimicrobial moieties, in order to prevent the functional molecules from migrating from the film. The polymer compositions and methods described above can be used to form articles of manufacture, such as gloves, condoms, finger cots, etc., which can be formed by contacting a mold in the shape of the articles of manufacture with the polymer compositions. The polymer compositions and methods may also be used to make binding agents in articles of manufacture such as gaskets, adhesives, coatings, or barrier films and membranes.

### DETAILED DESCRIPTION OF THE INVENTION

Various aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

Moreover, it will be understood that steps comprising the methods provided herein can be performed independently or at least two steps can be combined when the desired outcome can be obtained. The steps of the method may also be performed in any order, and the order of the steps provided herein should not be construed to limit the method steps to any particular or specific order. Additionally, steps comprising the methods provided herein, when performed independently or combined, can be performed at the same temperature or at different temperatures without departing from the teachings of the present invention.

The polymer composition of the invention is formed from olefinically unsaturated monomers wherein the polymer contains at least one conjugated diene monomer and additional functionality is provided by a monomer having the structure of Formula I: 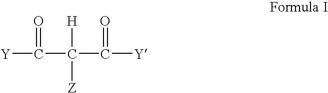 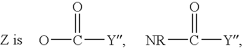
wherein
or Y″; wherein Y,Y″, and Y′ are independently selected from the group consisting of NRR′, OR or R wherein R and R′ are independently selected from the group consisting of hydrogen and aliphatic, alicyclic, aromatic and heteroaromatic groups and wherein the structure has olefinic unsaturation. The polymer composition will now be described further, and additional information may be found in U.S. Pat. No. 6,624,274 to Suddaby, which is incorporated herein in its entirety by reference.

Suitable conjugated diene monomers include, but are not limited to, C₄ to C₉ dienes such as, for example, butadiene monomers such as 1,3-butadiene, 2-methyl-1,3-butadiene, and the like. Blends or copolymers of the diene monomers can also be used. A particularly preferred conjugated diene is 1,3-butadiene. The polymer composition may also optionally include other olefinically unsaturated monomers.

Suitable olefinically unsaturated monomers include α,β-unsaturated carboxylic acids, their anhydrides, and their aliphatic, alicyclic, aromatic, and heteroaromatic (partial) ester or (partial) amides such that the carbon skeletons of the base alcohols and amines of the esters and amides contain from about 1 to 20 carbon atoms in their carbon skeletons. Other suitable olefinically unsaturated monomers include α,β-unsaturated nitriles, vinyl aromatics, vinyl halides, and vinyl esters of aliphatic carboxylic acids having between about 2 and 20 carbon atoms, and vinyl ethers of aliphatic, alicyclic, aromatic, and heteroaromatic alcohols having from 1 to 18 carbon atoms.

Sutiable α,β-unsaturated carboxylic acids include itaconic, maleic, fumaric, and preferably acrylic and methacrylic acid.

Suitable esters or amides include methyl(meth)acrylate, ethyl(meth)acrylate, propyl (meth)acrylate, isopropyl(meth)acrylate, butyl(meth)acrylate, sec-butyl(meth)acrylate, tert-butyl(meth)acrylate, 2-ethylhexyl(meth)acrylate, glycidyl(meth)acrylate, hydroxyethyl (meth)acrylate, hydroxypropyl(meth)acrylate, hydroxybutyl(meth)acrylate, β-carboxyethyl acrylate, monomethyl maleate, dimethyl maleate, monooctyl maleate, monomethyl itaconate, dimethyl itaconate, di(ethylene glycol) maleate, di(ethylene glycol) itaconate, 2-hydroxyethyl methyl fumarate, ethylene glycol di(meth)acrylate, hexamethylene glycol di(meth)acrylate, maleimide, 3-chloro-2-hydroxybutyl methacrylate, dimethylaminoethyl(meth)acrylate and their salts, 2-sulfoethyl(meth)acrylate and their salts, diethylaminoethyl(meth)acrylate and their salts, methoxy polyethylene glycol mono(meth)acrylate, tert-butylaminoethyl (meth)acrylate and their salts, benzyl(meth)acrylate, isobomyl(meth)acrylate, isodecyl (meth)acrylate, cyclohexyl(meth)acrylate, lauryl(meth)acrylate, methoxyethyl (meth)acrylate, hexyl(meth)acrylate, stearyl(meth)acrylate, allyl(meth)acrylate, ethoxylated nonylphenol(meth)acrylate, tridecyl(meth)acrylate, caprolactone (meth)acrylate, propoxylated allyl(meth)acrylate, tetrahydrofurfuryl(meth)acrylate, (meth)acrylamide, 2-acrylamido-2methylpropanesulfonic acid, N-isopropyl(meth)acrylamide, tert-butyl(meth)acrylamide, N,N′-methylene-bis-(meth)acrylamide, N,N-dimethyl(meth)acrylamide, and N-methylol(meth)acrylamide. Suitable vinylaromatic monomers include styrene, α-methylstyrene, p-methylstyrene, p-methoxystyrene, vinyl toluene, chlorostyrene, vinyl benzylchloride, vinyl pyridine, and vinyl naphthalene.

Suitable vinyl halides include vinyl chloride and vinylidene chloride.

Suitable unsaturated nitriles include acrylonitrile and methacrylonitrile.

As discussed above, the polymer composition of the invention additionally has a monomer with the general structure of Formula I. The monomer of Formula I permits crosslinking, curing, reaction with co-reacting functionalities on substrates, and/or reaction with functional molecules, such as plasticizers, dyes, indicators, surface modifiers, and antimicrobial moieties.

Suitable monomers of Formula I include esters of acetylacetic and diacetylacetic acids such as acetoacetoxyethyl(meth)acrylate, acetoacetoxypropyl(meth)acrylate, diacetoacetoxyethyl(meth)acrylate, diacetoacetoxypropyl(meth)acrylate, vinyl acetoacetate, vinyl diacetoacetate, allyl acetoacetate, and allyl diacetoacetate.

The polymers of the invention can be made by any suitable polymerization technique. Typically, the polymers are prepared by emulsion polymerization. One method of preparing the polymer is to use emulsion polymerization so that the polymer is obtained in the form of polymer latex. Conventional free radical initiation systems used in emulsion polymerization may be used in preparing these polymer latices. These initiation systems include, for example, peroxidic and diazo compounds such as ammonium persulfate, potassium persulfate, sodium persulfate, tert-butyl hydroperoxide, hydrogen peroxide, peroxydiphosphates, 4,4′-azobis(4-cyanovaleric acid), 2,2′-azobisisobutyronitrile, as well as redox systems known to one skilled in the art.

Conventional surfactants and emulsifying agents can be employed in the polymer composition and in the method of making the articles of manufacture. Polymerizable surfactants that can be incorporated into the polymer also can be used. For example, anionic surfactants can be selected from the broad class of sulfonates, sulfates, ethersulfates, sulfosuccinates, phosphates and the like, the selection of which will be readily apparent to anyone skilled in the art. Nonionic surfactants may also be used to improve film and glove characteristics, and may be selected from the family of alkylphenoxypoly(ethyleneoxy)ethanols where the alkyl group typically varies from C₇-C₁₈ and the ethylene oxide units vary from 4-100 moles. Various preferred surfactants in this class include the ethoxylated octyl and nonyl phenols. Ethoxylated alcohols are also desirable surfactants. A typical anionic surfactant is selected from the diphenyloxide disulfonate family, such as benzenesulfonic acid, dodecyloxydi-, disodium salt. In addition to, or in place of the surfactants, a polymeric stabilizer may be used in the composition of the invention.

Additional ingredients may include, but are not limited to, chelating agents (e.g., ethylenediaminetetraacetic acid); dispersants (e.g., salts of condensed naphthalenesulfonic acid); buffering agents (e.g., ammonium hydroxide); and polymerization inhibitors (e.g., hydroquinone). Chain transfer agents (e.g., carbon tetrachloride, butyl mercaptan, bromotrichloromethane, n-dodecyl mercaptan and t-dodecyl mercaptan) may also be used in the invention.

Typically, the polymer composition comprises about 5 to about 99.9 percent by weight of at least one olefinically unsaturated monomer, and from about 0.1 to about 30 percent by weight of the composition of the monomer of Formula I. In addition, the polymer composition includes one or more crosslinking agents in the amount of from about 0.1 to about 45 percent by weight of polymer. The compounding or mixing may be done in any suitable manner, and in many cases the latex composition will be carboxylated. The resultant properties may be varied depending on desired use of the particular article. For example, in dipped goods, the resulting latex composition typically yields a tensile strength greater than about 1500 psi and an elongation at break greater than about 400%.

The crosslinking agents may cure the polymers by reacting with the monomer of Formula I. To this end, crosslinking may be achieved by enamine formation, condensation with aldehydes, Michael reaction, alkylation with alkyl halides, reaction with isocyanates, or by reaction with melamines. The same reaction mechanisms may also be used to bind the polymer to a substrate having co-reacting functionalities or to bind functional molecules to the polymer.

The polymer composition of the invention may be cured via enamine formation by the addition of hydrazine or a compound comprising two or more primary or secondary amine functionalities. Enamines are formed when the (mono-substituted) 1,3-propanedioxyl functionality of the monomer of Formula I has an enol tautomeric form and the enolic hydroxyl reacts with the amine functionality. When a compound with two or more amines is reacted with two or more equivalents of a monomer of Formula I, a crosslink is formed between the (mono-substituted) 1,3-propanedioxyl groups of the monomers of Formula I. This curing reaction may be performed over a wide temperature range, including ambient temperatures. Preferably, the reaction is performed at ambient temperatures in the range of 20 to 25° C. at pH 8-10, under atmospheric pressure.

Suitable diamines for enamine formation include, but are not limited to, an aliphatic amine such as ethylenediamine, trimethylenediamine, tetramethylenediamine, hexamethylenediamine, nonamethylenediamine, diethylenetriamine and the like; an alicyclic amine, such as isophoronediamine, 4,4′-diaminodicyclohexylmethane, 4,4-diaminodicyclohexylpropane, hydrogenated xylenediamine, dipentenediamine, diaminomenthene and the like; a diamine of which an amino group is not directly bonded to an aromatic ring, such as α, α, α′, α′-tetramethylxylylenediamine, xylylenediamine; a secondary diamine represented by the following formula; 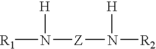
wherein R₁ and R₂ each independently represent methyl, ethyl, n-propyl, i-propyl, n-butyl, secbutyl, i-butyl, cyclopentyl, cyclohexyl, cyanoethyl and the like, and Z represents an alkylene, a cycloalkylene, an aryl residue, a polyether residue and the like; or any suitable cyclic diamine. Preferably, the polymer composition may be cured by the addition of hydrazine or a compound comprising two or more primary amine functionalities. Preferably, the compound comprising two or more amine functionalities is selected from the group consisting of 1,6-hexanediamine, ethylenediamine, hydrazine, triethyleneglycoldiamine, polyoxypropylenediamine, and 1,2-diaminocyclohexane. Further, the amine functionalities may be blocked or unblocked. Any suitable method of blocking the amine functionalities may be used. For example, Schiff bases such as ketimines can be used.

Additionally or alternatively, the polymer composition of the invention may also be reacted with fibers, surfaces, polymers, or other substrates comprising at least one primary or secondary amine functionality, so that the (mono-substituted) 1,3-propanedioxyl group of the polymer reacts with the amine functionalities of the substrate to bind the polymer to the substrate via enamine formation. Further, the polymer may react with a functional molecule comprising at least one primary or secondary amine functionality to bind the functional molecule to the polymer via enamine formation. Conditions for the reaction of the (mono-substituted) 1,3-propanedioxyl group of the polymer composition with a substrate or functional molecule will depend on the specific system used, but the reaction may proceed over a wide temperature range, including ambient temperatures.

The polymer composition of the invention may also be cured via aldehyde condensation by the addition of a compound comprising an aldehyde functionality. Aldehydes can rapidly condense with the active methylene or methylidene group of the (mono-substituted) 1,3-propanedioxyl group of the monomer of Formula I. This reaction can form bridges between proximate methylene or methylidene groups to crosslink the (mono-substituted) 1,3-propanedioxyl group of the monomer of Formula I. This curing reaction may be performed at a wide range of temperatures, including ambient temperatures. Preferably, the reaction is performed at ambient temperatures in the range of 20 to 25° C. The compound comprising an aldehyde functionality may be any suitable aldehyde, including, but not limited to, formaldehyde, acetaldehyde, crotonaldehyde, glyoxal, acrolein, benzaldehyde, furfural. Preferably, the compound comprising an aldehyde functionality is selected from the group consisting of formaldehyde, gluteraldehyde, acetaldehyde, and glycolic acid. Further, the aldehyde functionality may be blocked or unblocked, so that a compound that generates an aldehyde may also be used. Any suitable method of blocking and/or generating the aldehyde may be used. For example, hexahydro-1,3,5-triethyl-s-triazine, Zoldine™ ZT-55 (Angus Chemical Company) or an N-methylol-functionalized resin may be used.

Additionally or alternatively, the polymer composition of the invention may also be reacted with fibers, surfaces, polymers, or other substrates comprising ammonia or at least one aldehyde functionality, so that the (mono-substituted) 1,3-propanedioxyl group of the polymer reacts with the aldehyde functionalities of the substrate to bind the polymer to the substrate via aldehyde condensation. Further, the polymer may react with a functional molecule comprising at least one aldehyde functionality to bind the functional molecule to the polymer via aldehyde condensation. Conditions for the reaction of the (mono-substituted) 1,3-propanedioxyl group of the polymer composition with a substrate or functional molecule will depend on the specific system used, but the reaction may proceed over a wide temperature range, including ambient temperatures.

The polymer composition of the invention may also be cured via the Michael reaction by the addition of a base catalyst and a compound comprising two or more electron-deficient olefins. Here, the methylene or methylidene groups of the two or more equivalents of the monomer of Formula I are deprotonated by the base catalyst and then reacted with the compound comprising two or more electron-deficient olefins. A crosslink is formed when each electron-deficient olefin reacts with a different monomer of Formula I. The base catalyst can be any base with a pK_{b} greater than about 12.5. This includes, but is not limited to, sodium methoxide, potassium hydroxide, tetrabutylammonium hydroxide, tetramethylguanidine, 1,8-diazabicyclo(5.4.0)undec-7-ene, 1,5-diazabicyclo(4.3.0)non-5-ene, and sodium hydroxide. The term “electron-deficient olefin” is meant to refer to any olefin that will undergo the Michael reaction as described above. Any suitable olefin may be used, including, but not limited to, various acrylamides and acrylates such as ethylene glycol diacrylate, cyclohexane dimethanol diacrylate, alkoxylated hexane diol diacrylate, tripropyleneglycol diacrylate, ethyoxylated bisphenol A diacrylate, trimethylolpropane triacrylate, pentaerythritol tetraacrylate. This curing reaction may be performed at a wide range of temperatures, including ambient temperatures. Preferably, the reaction is performed at ambient temperatures in the range of 20 to 25° C.

Additionally or alternatively, the polymer composition of the invention may also be reacted with fibers, surfaces, polymers, or other substrates comprising at least one electron-deficient olefin, so that the deprotonated methylene or methylidene groups of the monomer of Formula I are reacted with the electron-deficient olefin of the substrate to bind the polymer to the substrate. Further, deprotonated methylene or methylidene groups of the monomer of Formula I may react with a functional molecule comprising at least one electron-deficient olefin to bind the functional molecule to the polymer via the Michael reaction. The conditions for the reaction of the deprotonated methylene or methylidene groups of the polymer composition with a substrate or functional molecule will depend on the specific system used, but the reaction may proceed over a wide temperature range, including ambient temperatures.

The polymer composition of the invention may also be cured via alkylation by the addition of a base and a compound comprising two or more alkyl halide functionalities, wherein the alkyl halide functionalities are each independently alkyl chloride, alkyl bromide or alkyl iodide. Here, the methylene or methylidene groups of two or more equivalents of the monomer of Formula I are deprotonated by the base and then reacted with the compound comprising two or more alkyl halide functionalities. A crosslink is formed when each alkyl halide functionality reacts with a different monomer of Formula I. The compound comprising two ore more alkyl halide functionalities includes, but is not limited to, 1,4-dichlorobutane, polyvinyl chloride, α, α′-dibromo-p-xylene, and 1,12-dibromododecane. The base may be any base with a pK_{b} greater than 12.5, which includes, but is not limited to, sodium methoxide, potassium hydroxide, tetrabutylammonium hydroxide, and sodium hydroxide. This curing reaction may be performed at temperatures at a wide range of temperatures, including ambient temperatures. Preferably, the reaction is performed at ambient temperatures in the range of 20 to 25° C.

Additionally or alternatively, the polymer composition of the invention may also be reacted with fibers, surfaces, polymers, or other substrates comprising at least one alkyl halide functionality, so that the deprotonated methylene or methylidene groups of the polymer may react with the alkyl halide functionalities of the substrate to bind the polymer to the substrate via alkylation. Further, deprotonated methylene or methylidene groups of the polymer may react with a functional molecule comprising at least one alkyl halide functionality to bind the functional molecule to the polymer via alkylation. Conditions for the reaction of the deprotonated methylene or methylidene groups of the polymer composition with a substrate or functional molecule will depend on the specific system used, but the reaction may proceed over a wide temperature range, including ambient temperatures.

The polymer composition of the invention may also be cured by the addition of a compound comprising two ore more isocyanate functionalities. The active methylene or methylidene groups of the monomer of Formula I can undergo reactions with free or blocked isocyanate groups. When a compound comprising two or more isocyanate functionalities is added to the two ore more equivalents of the monomer of Formula I, bridges are formed between monomers of Formula I. Any suitable compound comprising two or more isocyanate functionalities may be used including, but not limited to, 2,4-and 2,6-toluene diisocyanate, 1,4-phenylene diisocyanate, naphthylene diisocyanate, diphenylmethane diisocyanate, α,ω-alkylene diisocyanates such as hexamethylene diisocyanate, and isophorone diisocyanate. Preferably, the compound comprising two or more isocyanate functionalities is selected from the group consisting of 2,4-toluene diisocyanate, 1,4-phenylene diisocyanate, and diphenylmethane diisocyanate. Curing of the compound comprising two or more isocyanate functionalities may be performed at wide range of temperatures, including ambient temperature. Preferably, curing of unblocked isocyanate functionalities is performed at ambient temperatures in the range of 20 to 25° C. Preferably, curing of blocked isocyanate functionalities is performed at elevated temperatures to activate the blocked isocyanates.

Additionally or alternatively, the polymer composition of the invention may also be reacted with fibers, surfaces, polymers, or other substrates comprising at least one isocyanate functionality, so that the active methylene or methylidene groups of the polymer may react with the alkyl halide functionalities to bind the polymer to the substrate. Further, active methylene or methylidene groups of the polymer may react with a functional molecule comprising at least one isocyanate functionality to bind the functional molecule to the polymer. Conditions for the reaction of the active methylene or methylidene groups of the polymer composition with a substrate or functional molecule will depend on the specific system used, but the reaction may proceed at a wide temperature range, including ambient temperatures.

The polymer composition of the invention may also be cured by the addition of a reactive melamine. The active methylene or methylidene groups of the monomer of Formula I may undergo reactions with reactive melamines to form bridges between monomers of Formula I. This curing reaction may be performed at a wide range of temperatures. Preferably, the reaction is performed at temperatures greater than about 120° C. The temperature required is dependent on the melamine and structure of the monomer of Formula I used. In addition, any suitable acid catalyst known to one of skill in the art may be used. Any suitable melamine may be used, including monomeric or polymeric melamine resins and partially or fully alkylated melamine resins. Examples of commercially available resins are Cymel® 1168, Cymel® 1161, Cymel® 1158 and Cymel® 1156, produced by the American Cyanamid Company. Preferably, the melamine used is selected from the group consisisting of hexamethoxymethyl melamine, methoxymethyl melamine resins, butylated melamine resins, and alkylated melamine resins.

Additionally or alternatively, the polymer composition of the invention may also be reacted with fibers, surfaces, polymers, or other substrates comprising at least one reactive melamine functionality, so that the active methylene or methylidene groups may react with the reactive melamine functionalities to bind the polymer to the substrate. Further, active methylene or methylidene groups of the polymer may react with a functional molecule comprising at least one reactive melamine functionality to bind the functional molecule to the polymer. Conditions for the reaction of the active methylene or methylidene groups of the polymer composition with a substrate or functional molecule will depend on the specific system used, but generally temperatures of greater than 120° C. are required.

The polymer compositions of the invention may also be modified by reacting the monomer of Formula I with reagents which alter the reactivity of the monomer and allow the monomer to undergo further reactions which are known to one skilled in the art. For example, the polymer composition of the invention may be reacted with ammonia or a primary or secondary amine to form an enamine. The resulting enamine may undergo further reactions, such as Michael addition, when in the presence of a base catalyst such as triphenyl phosphine.

Numerous articles of manufacture can be formed from the crosslinked, cured, or reactive polymer compositions of the invention. Such latex articles generally include those which are typically made from natural rubber and which contact the human body. The films can be made into self-supported stable articles. The films are mechanically self-supporting without significant deformation, i.e., it can maintain its dimensions (e.g., length, thickness, circumference, etc.) against gravity without any exterior support such as a mold. It is recognized by those skilled in the art, the article could be supported, e.g., lined, if additional support is desired. Exemplary articles of manufacture include, but are not limited to, gloves, condoms, medical devices, catheter tubes, bags, balloons, and blood pressure bags. Exemplary techniques are described in U.S. Pat. No. 5,084,514 to Szczechura et al., the disclosure of which is incorporated by reference herein in its entirety.

Any suitable techniques may be used to practice the method of the invention. For example, suitable forms or molds in the shape of a hand are heated in an oven and are optionally immersed or dipped into a coagulant. A suitable coagulant includes, for example, a solution of a metal salt, preferably calcium nitrate, in water or alcohol. The form is then withdrawn from the coagulant, and the excess liquid is permitted to dry. As a result, a residual coating of coagulant is left on the form. The form coated with the coagulant is then immersed or dipped into the polymer dispersion containing the polymer composition of the present invention. The latex coagulates and forms a film on the form. The amount of time the form is immersed in the latex typically determines the thickness of the film. The longer the dwell time, the thicker the film.

Optionally, the crosslinking agent could be compounded into the polymer dispersion prior to dipping. It may also be applied to the form prior to dipping of the polymer dispersion (possibly a coagulant system), i.e. used as an underdip. It may also be applied after the polymer dispersion has been applied to the form as an overdip, overspray, or vapor. It may also be applied during post-processing of the dipped article. The options for application of the invention will be apparent to one of skill in the art. The options will depend both on the specific process being used and the specific reaction being applied. Furthermore, one skilled in the art will recognize the potential to engineer the properties of the finished good; conditions may be selected that would result in non-uniform properties. For example, it is possible to select conditions whereby only one or both surfaces of the finished good would be impacted or where the composition would vary through the depth of the article (e.g. to reduce tack or surface harden the article, or to bind a material to a single surface of the article).

The form is then removed from the latex and is immersed in a water bath to remove the coagulant and some of the surfactant. The latex coated form is then placed in a drying oven at a temperature preferably between about 60° C. and about 100° C. to remove water from the film. When the film is dry, the mold is either cured at ambient temperature or is placed in a curing oven preferably at a temperature in the range of 70 to 150° C. If desired, the same oven can be used for drying and curing, and the temperature can be increased with time.

The glove is then removed from the form. It may be powdered or post-processed for ease of removal and for ease of donning. The glove preferably has a thickness ranging from about 3 mil to about 20 mil.

In-addition to the above, a crosslinked film produced in accordance with the invention can contain additional(at least a second) polymeric films in contact thereto so as to form composite structures. The application of the additional polymeric films may be achieved by techniques known in the art. For example, the polymeric films may be formed on the crosslinked film and article by coating, spraying, or “overdipping.” The resulting materials may then be dried and cured in accordance with known and accepted techniques. The additional polymeric films may be formed from a wide number of materials including, but not limited to, neoprene, nitrites, urethanes, acrylics, polybutadiene, polyisoprene, and the like. Mixtures of the above may also be used. The additional polymeric films may be present in a variety of configurations. For example, in one embodiment, an additional film may be positioned above the crosslinked film. In a second embodiment, an additional film may be positioned below the crosslinked film. In a third embodiment, the crosslinked film may be located between two additional films. The configurations of different films may be selected as desired by the skilled artisan.

The crosslinked film of the invention may be used in conjunction with other conventional materials, such as textile substrates which may be present in the form of an article such as a glove, for example. As an example, supported gloves are well known in the art. In this instance, the crosslinked film typically covers or is lined by the textile substrate, although other configurations are possible. For the purposes of the invention, the term “textile” is to be broadly interpreted and may be formed from a variety of synthetic and natural materials such as, but not limited to, nylon, polyester, and cotton. Blends and mixtures thereof may also be used.

Another use of the polymer composition is for gaskets such as described in Published Patent Application No. 2002/0117815, the disclosure of which is incorporated herein by reference in its entirety. Fiber-based gaskets are currently manufactured on a paper machine, using either a Fourdriner or Cylinder machine. Various fibers, fillers, and latexes are incorporated depending on the end-performance requirements, the selection of which will be within the skill of one in the art. The primary purpose of a gasket is to seal or provide a barrier to the interfaces of imperfect or incompatible parts. The proper gasket selection is made after a careful review of the conditions the gasket is likely to encounter. This includes the condition of the flange being sealed, the amount of torque placed on the flange, the fluids that the gasket may encounter and the temperature at which the gasket is exposed. In order to obtain the best compression resistance, a curative is incorporated to cross-link the polymer under elevated temperatures. The specific crosslink temperature can be obtained during a secondary treatment to the gasket before shipping, or it may be obtained once the gasket is in place. For butadiene copolymers, the conventional cure package consists of sulfur, accelerator, and zinc oxide (vulcanizing package). While this cure package is effective in providing the required performance properties, it also has several negative features associated with the use of sulfur. Namely, excess sulfur blooms to the surface of the gasket with time. This causes a dusty residue that interferes with post treatments such as a release coat, laminating adhesive, or trade-marking. Additionally, excess sulfur is a nuisance to plant workers during the post-curing process when excessive smoke and fumes are generated. Excessive sulfur also inhibits the cure mechanism of post-added silicone beading. Excess sulfur does not improve the overall cure of the gasket and is a negative expense. Thus use of the polymer of the present invention obviates the need to use sulfur in the cure package.

The following examples are merely illustrative of the invention, and are not limiting thereon.

### EXAMPLE 1

147.5 phm of demineralized water, 2.75 phm of sodium dodecylbenzenesulfonate, 0.05 phm of the ammonium salt of EDTA, 0.2 phm of the sodium salt of condensed naphthalene sulfonic acid, 0.1 phm fo tetrapotassium pyrophosphate, 0.6 phm of tert-dodecylmercaptan, 58 phm 1,3-butadiene, 36 phm acrylonitrile, 3 phm methacrylic acid and 3 phm of acetoacetoxyethyl methacrylate was charged into a reactor. The temperature of the mixture was raised to 115° F. and 0.025phm of potassium persulfate was added. The temperature was raised to 120° F. 390 minutes after adding the potassium persulfate, and 125° F. at 445 minutes, and 130° F. at 515 minutes. At 9.5 hrs the conversion was determined to by 89.8%, and 0.72 phm triethanolamine and 0.75 phm Bostex 728 was added. The latex was concentrated to 44.8% solids.

### EXAMPLE 2

The latex described in Example 1 was mixed with 1 phr sodium dodecylbenzenesulfonate and 0.2 phr Proxel GXL. Triethanolamine was added to raise the pH to approximately 8.8. A 5% hexamethylenediamine (HMDA) solution was prepared by mixing 5 parts of hexamethylenediamine with 41.8 parts sodium dodecylediphenyloxide disulfonate and 46.8 parts water. HMDA was added to the latex in the form of this solution. Table 1 shows the evolution of gel(measured in tetrahydrofuran) of HMDA treated samples of the latex as they aged at ambient temperatures. The indicated amount of active HMDA was added as the solution described above. The increase in gel with time shows that crosslinking is occurring.

TABLE 1

Gel

| Time (hr) | 0.41 phr HMDA | 0.82 phr HMDA |
|---|---|---|
| 0.2 | 41.7 | 51.7 |
| 2 | 67.6 | 75.4 |
| 4 | 77.7 | 85.4 |
| 6 | 79.8 | 86.1 |
| 24 | 84.3 | 89.3 |
| 48 | 86.2 | 89.4 |

### EXAMPLE 3

The latex described in Example 1 was mixed with 1 phr sodium dodecylbenzenesulfonate and 0.2 phr Proxel GXL. Triethanolamine was added to raise the pH to approximately 8.8. Table 2 show the evolution of gel(measured in tetrahydrofuran) of the latex in the presence of aldehydes or aldehyde generators at ambient temperatures. The increase in gel with time shows that crosslinking is occurring.

TABLE 2

| | Gel | | |
|---|---|---|---|
| | 0.105 phr | 0.875 phr Zoldine | 0.308 phr |
| Time (hr) | Formaldehyde | ZT 55 | Acetaldehyde |
| 0* | 47.5 | 25.8 | 25.7 |
| 2 | 70.6 | 59.3 | 26.7 |
| 4 | 78.6 | 70.7 | 33 |
| 8 | 81 | 77.5 | 38.3 |
| 16 | 86.9 | 85.4 | 56.8 |
| 24 | 86.2 | 87.8 | 64.7 |
| 40 | — | 90.5 | 75.5 |
| 48 | 88 | 92 | 77.4 |

*immediately after mixing

The foregoing is illustrative of the present invention, and is not to be construed as limiting thereof. The invention is defined by the following claims, with equivalents of the claims to be included therein.

1. A polymer composition comprising at least one olefinically unsaturated monomer, wherein said polymer composition contains at least one conjugated diene monomer and additional functionality is provided by a monomer having the structure of Formula I 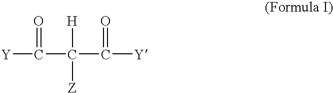
wherein 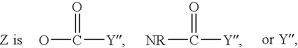
wherein Y, Y′ and Y″ are independently selected from the group consisting of NRR′, OR, or R wherein R and R′ are independently selected from the group consisting of hydrogen and aliphatic, alicyclic, aromatic and heteroaromatic groups, wherein the structure has olefinic unsaturation, wherein said polymer composition is cured with hydrazine or a compound comprising two or more primary or secondary amine functionalities, and wherein the hydrazine or the primary or secondary amine functionalities are each independently blocked or unblocked.

2. A method of making an article of manufacture, the method comprising the steps of:
a) contacting a mold in the shape of the article of manufacture with a polymer formed from at least one olefinically unsaturated monomer, wherein the polymer contains at least one conjugated diene monomer and additional functionality is provided by a monomer having the structure of Formula I 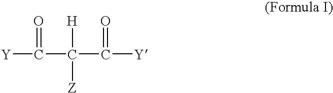
wherein 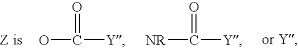
wherein Y, Y′ and Y″ are independently selected from the group consisting of NRR′, OR or R wherein R and R′ are independently selected from the group consisting of hydrogen and aliphatic, alicyclic, aromatic and heteroaromatic groups, and wherein the structure has olefinic unsaturation; and
b) curing the polymer by adding hydrazine or a compound comprising two or more primary or secondary amine functionalities to crosslink the polymer to provide the article of manufacture, wherein the hydrazine or the primary or secondary amine functionalities are independently blocked or unblocked.

3. A method according to claim 2, wherein the compound comprising two or more primary amine functionalities is selected from the group consisting of 1,6-hexanediamine, ethylene diamine, hydrazine, triethyleneglycoldiamine, polyoxypropylenediamine, and 1,2-diaminocyclohexane.

4. A method according to claim 2, wherein said curing of the polymer occurs at ambient temperature.

5.-36. (canceled)
